(19) United States
(12) Patent Application Publication
(10) Pub. No.: US 2010/0158524 A1
(43) Pub. Date: Jun. 24, 2010

(54) UPSTREAM SOURCE LIGHT GENERATOR OF PASSIVE OPTICAL NETWORK SYSTEM AND METHOD OF GENERATING UPSTREAM SOURCE LIGHT

(75) Inventors: Oh-Kee KWON, Daejeon (KR); Yongsoon Baek, Daejeon (KR); Chul-Wook Lee, Daejeon (KR); Jong-Hoi Kim, Daejeon (KR); Eundeok Sim, Daejeon (KR); Dong-Hun Lee, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/543,031

(22) Filed: Aug. 18, 2009

(30) Foreign Application Priority Data
Dec. 18, 2008 (KR) 2008-129530

(51) Int. Cl. H04J 14/00; G02B 6/34; H04B 10/00

(52) U.S. Cl. 398/70; 385/37; 398/168

(57) ABSTRACT

Provided is an upstream source light generator of a passive optical network (PON) system. The upstream source light generator includes an amplification part configured to amplify injection light, and a reflection part configured to receive the amplified injection light and generate reflection light by reflecting the amplified injection light with different optical delays according to wavelengths of the amplified injection light.

### CROSS-REFERENCE TO RELATED APPLICATIONS

This U.S. non-provisional patent application claims priority under 35 U.S.C. §119 of Korean Patent Application No. 10-2008-0129530, filed on Dec. 18, 2008, the entire contents of which are hereby incorporated by reference.

### BACKGROUND OF THE INVENTION

The present invention disclosed herein relates to an optical communication system, and more particularly, to a source light generator of a passive optical network system and a method of generating source light using the source light generator.

Fiber to the home (FTTH) technology is being developed to transmit large amounts of data through an optical fiber connected from a telephone company to the home in our current high-speed internet and multimedia service environments. Although various optical networks have been studied to realize FTTH technology, cost-effective equipment that enables transmission of large amounts of information is still needed in order to fully commercialize FTTH technology.

The purpose of FTTH technology is to connect an optical communication system to households. An optical communication system constructed based on FTTH technology can provide a 100-Mbps or higher transmission rate and integrated voice, data, and video services through an optical network. That is, triple-play service (TPS) can be provided through FTTH technology.

A wavelength division multiplexed-passive optical network (WDM-PON) is a representative FTTH network. In a WDM-PON, a central office (hereinafter referred to as a CO) allocates different wavelengths to optical network units (hereinafter referred to as ONUs) and transmits data simultaneously to the ONUs. Although a transmission line is shared by a plurality of ONUs, the ONUs can be handled individually. That is, although all ONUs physically share one optical fiber, point-to-point communication is possible between the ONUs and an optical line terminal (hereinafter, referred to as an OLT) of the CO. Therefore, a WDM-PON can provide a high security level and can be limited less by transmission methods. Furthermore, in a WDM-PON, a request of each ONU such as an additional communication service request or a communication capacity increase request can be easily accepted. Moreover, even when one or some of the ONUs break down, malfunction of the whole WDM-PON can be prevented.

For the above-mentioned communication, a WDM-PON should have optical sources having wavelengths corresponding to channels allocated to the ONUs. In addition, there are difficulties in managing and inspecting respective wavelengths allocated to the ONUs and aligning and controlling optical sources and optical components of the WDM-PON.

### SUMMARY OF THE INVENTION

The present invention provides an optical source having a flat gain and a dispersion compensation function.

Embodiments of the present invention provide upstream source light generators of a passive optical network (PON) system, the upstream source light generators including: an amplification part configured to amplify injection light; and a reflection part configured to receive the amplified injection light and generate reflection light by reflecting the amplified injection light with different optical delays according to wavelengths of the amplified injection light, wherein the reflection part has reflectivity varying according to the wavelengths of the amplified injection light.

In other embodiments of the present invention, RSOAs includes: an optical signal amplification region configured to amplify incident injection light; and a reflection region configured to reflect the amplified injection light with different reflectivities or optical delays according to wavelengths of the amplified injection light.

In still other embodiments of the present invention, there are provided methods of generating upstream source light in a WDM-PON (wavelength division multiplexed-passive optical network) system including a CO (central office) and an ONU (optical network unit), the method including: amplifying injection light provided by the CO; and reflecting the amplified injection light with different reflectivities or optical delays according to wavelengths of the amplified injection light so as to output the reflected injection light as upstream source light.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating an exemplary passive optical network according to an embodiment of the present invention;

FIG. 2 is a sectional diagram illustrating an exemplary structure of an upstream source light generator according to an embodiment of the present invention;

FIGS. 3A through 3C are diagrams illustrating reflectivity and group delay characteristics of a reflection part with respect to frequency according to an embodiment of the present invention;

FIGS. 4A through 4C are diagrams for explaining a method of obtaining a flat optical gain from a reflective optical source according to an embodiment of the present invention; and

FIG. 5 is a simulation graph illustrating a reflectivity-wavelength relationship of a reflection part according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the specification, the dimensions of layers and regions are exaggerated for clarity of illustration. It will also be understood that when a layer (or film) is referred to as being ‘on’ another layer or substrate, it can be directly on the other layer or substrate, or intervening layers may also be present. Also, though terms like a first, a second, and a third are used to describe various regions and layers in various embodiments of the present invention, the regions and the layers are not limited to these terms. These terms are used only to tell one region or layer from another region or layer. Therefore, a layer referred to as a first layer in one embodiment can be referred to as a second layer in another embodiment. An embodiment described and exemplified herein includes a complementary embodiment thereof.

In addition, the technical features of the present invention will now be described with reference to exemplary optical signals of three wavelengths λ₁, λ₂, and λ₃ to provide easy and clear understanding of the present invention. However, the optical signals are used only for illustrative purpose to denote optical signals corresponding to a short wavelength λ₁, a center wavelength λ2, and a long wavelength λ₃ of a limited channel band. The illustrated wavelengths are not limited to particular wavelengths.

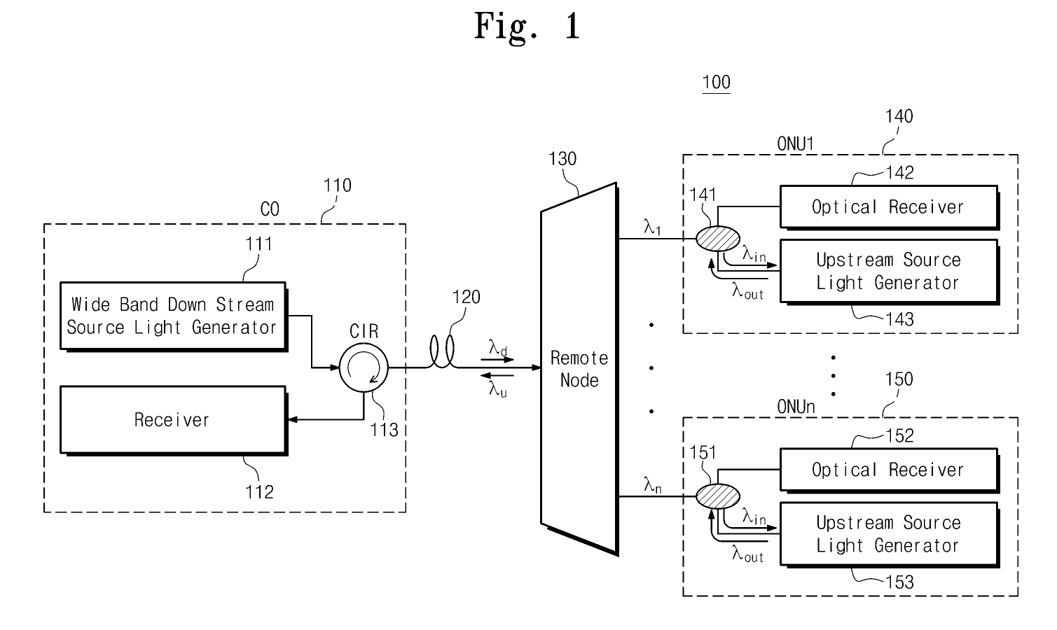

FIG. 1 is a block diagram illustrating an exemplary wavelength division multiplexed-passive optical network (WDM-PON) 100 according to an embodiment of the present invention. Referring to FIG. 1, the WDM-PON 100 may include a central office (CO) 10, an optical fiber 120, a remote node 130, and optical network units ONU1 140 to ONUn 150.

The CO 110 includes a wideband downstream source light generator 111, a receiver 112, and a circulator 113. The wideband downstream source light generator 111 generates and outputs a downstream optical signal λ_{d} having a wideband wavelength. The receiver 112 receives upstream optical signals λᵤ output from the ONU1 140 to ONUn 150. The circulator 113 is switched for transmitting a downstream optical signal λ_{d} output from the wideband downstream source light generator 111 or upstream optical signals λᵤ output from the ONU1 140 to ONUn 150. The wideband downstream source light generator 111 generates a downstream optical signal λ_{d} having a wide spectrum, and the downstream optical signal λ_{d} is incident onto the optical fiber 120 through the circulator 113. Thereafter, the downstream optical signal λ_{d} is divided into a plurality of downstream optical signals λ₁ to λₙ (where n is a natural number) according to the wavelength of the downstream optical signal λ_{d} by an arrayed-waveguide grating (AWG) of the remote node 130. Then, the downstream optical signals λ₁ to λₙ are transmitted from the remote node 130 to the ONU1 140 to ONUn 150.

The ONU1 140 includes an optical coupler/splitter 141, an optical receiver 142, and an upstream source light generator (upstream optical source) 143. A downstream optical signal λ₁ transmitted to the ONU1 140 is distributed to the optical receiver 142 and the upstream source light generator 143 by the optical coupler/splitter 141. Upstream source light λₒᵤₜ which is output from the upstream source light generator 143 or upstream source light λₒᵤₜ which is additionally modulated is delivered to the remote node 130 through the optical coupler/splitter 141. The ONU1 140 may further include a component, which is configured to generate an upstream optical signal (not shown) having an allocated wavelength by using upstream source light λₒᵤₜ generated by the upstream source light generator 143.

The optical receiver 142 receives a downstream optical signal λ₁ transmitted through the optical coupler/splitter 141. The upstream source light generator 143 generates upstream source light λₒᵤₜ which may be transmitted from the ONU1 140 to the CO 110. The upstream source light generator 143 generates upstream source light λₒᵤₜ by amplifying incident injection light λᵢₙ. The upstream source light generator 143 may have a reflective semiconductor optical amplifier (RSOA) structure. Other ONUs, such as the ONUn 150 that shares the remote node 130 with the ONU1 140, are configured to generate upstream source light λₒᵤₜ in the same manner as the ONU1 140. Upstream source light λₒᵤₜ generated by the ONU1 140 to ONUn 150 may be coupled to each other by the remote node 130 as upstream optical signals λᵤ and transmitted to the CO 110 through the optical fiber 120.

In the current embodiment of the present invention, upstream source light generators 143 to 153 of the ONU1 140 to ONUn 150 have flat gain characteristics. In addition, the upstream source light generators 143 to 153 have structures for compensating for dispersion caused by group delay.

In the current embodiment of the present invention, each of the upstream source light generators 143 to 153 generates upstream source light λₒᵤₜ by amplifying injection light λᵢₙ, received from the CO 110 instead of generating the upstream source light λₒᵤₜ by its own single mode. An upstream optical source operating in this way is called “a reflective optical source.” Since upstream source light λₒᵤₜ is generated by amplifying and reflecting injection light λᵢₙ, the term “reflective optical amplifier” is also used. Since the upstream source light generators 143 to 153 are reflective optical sources or reflective optical amplifiers, the upstream source light generators does not include components capable of emitting upstream source light λₒᵤₜ. Therefore, the WDM-PON 100 can be economically constructed.

In addition, the upstream source light generators 143 to 153 have flat gain and dispersion compensation characteristics. The flat gain characteristics mean that the same optical gain level can be obtained over a wavelength band allocated to the ONU (ONU1 140 to ONUn 150). Owing to these characteristics, a Fabry-Perot laser diode (FP-LD) or an RSOA having the same gain level over a wavelength band allocated to the ONU (ONU1 143 to ONUn 150) can be provided.

In an optical fiber based communication, the gain of propagating light is characterized by a Gaussian type distribution having a limited band in a wavelength region. Therefore, if the number of channels increases or the operational temperature varies, gain characteristics of channels vary, and thus, operational conditions (i.e., the intensity of injection light or the magnitude of an injection current) should be adjusted according to the gain variation. However, according to the present invention, since the upstream source light generators 143 to 153 have flat gain characteristics, each of the OUN1 140 to ONUn 150 having allocated channels can have uniform gain characteristics under the same operation conditions.

The dispersion compensation characteristics mean that the optical fiber 120 is compensated for dispersion by upstream source light λₒᵤₜ generated by the upstream source light generators 143 to 153. If upstream source light λₒᵤₜ capable of dispersion compensation is provided, signal quality degradation caused by group delay or chromatic dispersion of upstream optical signals λᵤ can be reduced. Owing to the dispersion compensation, the transmission distance of an optical signal can be increased.

In the current embodiment of the present invention, since the upstream source light generators 143 to 153 have flat gain and dispersion compensation characteristics, the WDM-PON 100 can be easily expanded for increasing the number of channels. In addition, since the WDM-PON 100 can be constituted by a system having an increased transmission distance, the WDM-PON 100 can be constructed with low costs.

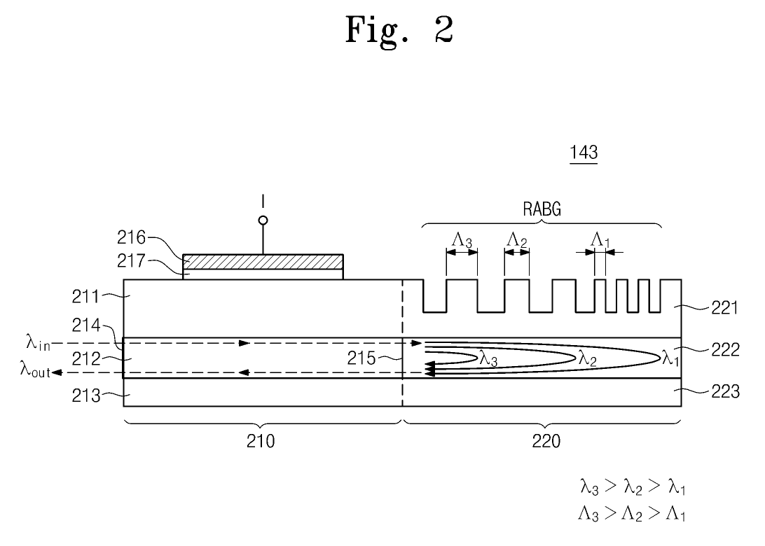

FIG. 2 is a sectional view illustrating an exemplary structure of the upstream source light generator 143 according to an embodiment of the present invention. Referring to FIG. 2, the upstream source light generator 143 includes an amplification part 210 and a reflection part 220. That is, the upstream source light generator 143 has a reflective optical amplifier structure having amplification and reflection functions. The upstream source light generator 143 will now be described in more detail.

The amplification part 210 includes a gain waveguide 212 having a predetermined optical gain for amplifying injection light λᵢₙ. Upper and lower clads 211 and 213 are disposed on the top and bottom sides of the gain waveguide 212. An upper electrode 216 and an ohmic layer 217 are disposed at the upper clad 211. A modulation current (I) is applied to the upper electrode 216 for adjusting the optical gain of a gain medium of the gain waveguide 212.

The ohmic layer 217 may be disposed between the upper electrode 216 and the upper clad 211. A first anti-reflection coating surface 214 is formed on an entrance surface of the gain waveguide 212. In addition, a substrate (not shown) may be disposed at the bottom side of the lower clad 213. A lower electrode (not shown) may be disposed at the bottom side of the substrate. The above-described amplification part 210 may be a laser diode. Alternatively, the amplification part 210 may be an FP-LD, an RSOA, or a semiconductor optical amplifier (SOA).

The reflection part 220 includes a clad 221, and a reflection-type asymmetric Bragg grating (RABG) is formed at the top side of the clad 221. A passive waveguide 222 is disposed at the bottom side of the clad 221 for guiding amplified injection light incident from the amplification part 210. A clad 223 is disposed at the bottom side of the passive waveguide 222. A second anti-reflection coating surface 215 may be disposed between the gain waveguide 212 and the passive waveguide 222.

The RABG is formed by selectively etching the top side of the clad 221. The grating period of the RABG varies with a predetermined ratio. The RABG may be formed by photolithography. For example, the RABG may be formed by dry etching or wet etching. That is, the RABG may be formed in a micro-groove structure by etching the top side of the clad 221.

A plurality of grating ridges of the RABG may be formed in a manner such that the grating period Λa (where “a” denotes a grating region) of the grating ridges decreases in the length direction of the passive waveguide 222. In addition, the depth of grooves of the RABG may vary like the grating period Λa of the RABG. The grating period Λa of the RABG, which is formed using an etching pattern as described above, may vary according to frequency (λ). For example, the grating period Λa of the RABG may be about 1 μm or smaller for an optical signal having a wavelength of about 1550 nm. In addition, the grooves of the RABG formed between the grating ridges of the RABG may be filled with a polymer or an index matching material having a refractive index different from that of the clad 221.

The reflection mechanism of the RABG is as follows. Some of injection light λᵢₙ propagating from the amplification part 210 to the passive waveguide 222 is transmitted to the clad 221 where the injection light λᵢₙ confronts the RABG. The refractive index or effective refractive index of the passive waveguide 222 varies periodically in the direction of the passive waveguide 222 owing to the RABG. Therefore, some of the injection light λᵢₙ transmitted to the passive waveguide 222 is reflected and the other is transmitted by the influence of diffraction. The relationship between the grating period Λa of the RABG and reflection wavelength λa can be expressed by Equation 1 below.

$$\frac{2 π n}{λ a} = \frac{m π}{Λ a} \qquad [ Equation 1 ]$$

where “n” denotes the effective refraction index of the RABG and “m” denotes diffraction order.

In Equation 1, the reflection wavelength λa can be adjusted by varying the grating period Λa of the RABG. The reflectivity of the RABG can be adjusted by varying a parameter (coupling coefficient x grating length) of the RABG. The spectrum width of the RABG can be simply determined by adjusting the parameter (coupling coefficient×grating length) and the grating period Λa (for example, in a chirped grating fashion). The coupling coefficient of the RABG denotes the influence of the RABG on light incident on the passive waveguide 222. The coupling coefficient of the RABG increases in proportion to the depth of the grooves of the RABG but in reverse proportion to the refraction index of the passive waveguide 222. In the current embodiment, the grating period Λa of the RABG is set to Λ₃ at a region close to the amplification part 210 so as to reflect a long wavelength λ₃ of injection light λᵢₙ first. The grating period Λa of the RABG is set to Λ₁ at a region distant from the amplification part 210 so as to reflect a short wavelength λ₁ of the injection light λᵢₙ, later.

Therefore, in upstream source light λₒᵤₜ formed by optical signals reflected from the reflection part 220, a long wavelength optical signal λ₃ may be located at a leading position, and a short wavelength optical signal λ₁ may be located at a trailing position. Thus, owing to the wavelength based reflection order of the reflection part 220, chirping can be reduced during direct modulation at the gain waveguide 212. In addition, chromatic dispersion can be compensated for, which is caused by wavelength dependent optical delay when light is reflected from the reflection part 220 to an optical fiber.

As described above, the upstream source light generator 143 has a RSOA structure. The amplification part 210 and the reflection part 220 may be provided in the form of an integrated planner lightwave circuit (PLC). That is, the reflection part 220 may be fabricated by making the passive waveguide 222 using silica or polymer and forming the RABG at the top side of the passive waveguide 222. In this case, the reflection part 220 and the amplification part 210 may be fabricated by a hybrid integration method. If the passive waveguide 222 and the gain waveguide 212 are formed of the same compound semiconductor (InGaAsP/InP), the reflection part 220 and the amplification part 210 may be fabricated by a monolithic integration method.

The gain waveguide 212 of the amplification part 210 may be formed of a compound semiconductor (InGaAsP/InP) having a quantum well structure and a band gap of about 1.55 μm. The clads 211 and 213 of the amplification part 210, and the clad 221 including the RABG may be formed of p-InP. The ohmic layer 217 may be formed of p⁺-InGaAs. A current blocking structure may be formed in the clad 211 in the vicinity of the gain waveguide 212 for restricting a passage of a current applied through the upper electrode 216. The current blocking structure may be a buried heterostructure formed of at least one of p-InP and n-InP. The first and second anti-reflection coating surfaces 214 and 215 may have a stacked structure including a titanium oxide layer and a silicon oxide layer, and the thicknesses of the first and second anti-reflection coating surfaces 214 and 215 may be determined according to the wavelength of injection light king

The structure of the reflection part 220 is not limited to the above-described structure. In the embodiment shown in FIG. 2, the reflection part 220 includes the RABG. However, instead of the RABG, the reflection part 220 may include multiple thin-film layers formed of different materials. For example, the multiple thin-film layers may be formed by depositing a plurality of thin-film layers on the second anti-reflection coating surface 215. In the case where a gain medium such as a vertical cavity surface emitting laser (VCSEL) is used, the reflection part 220 may be formed by a growing method. That is, the reflection structure of the reflection part 220 is not limited to a diffraction grating such as the RABG.

In the case where the reflection part 220 employs a diffraction grating structure as a reflection structure, the diffraction grating structure of the reflection part 220 can be varied or modified in various ways. For example, the RABG of the reflection part 220 may be configured by a fiber Bragg grating (FBG) having the above-described spectrum characteristics. For instance, an FBG may be formed on the outer surface of a clad of an optical fiber in the shape of an RABG. In this case, the upstream source light generator 143 may be configured through a simple optical coupling between the reflection part 220 including the FBG and the amplification part 210.

Since the diffraction grating structure of the present invention can be formed in various structures as described above, particular technology is not necessary for fabricating or realizing the diffraction grating structure. That is, the arrangement and shape of the diffraction grating structure are not limited to particular arrangements and shapes. Birefringence can be lowered in the case where the reflection part 220 includes a FBG structure or a diffraction grating structure formed at a silica or polymer waveguide. In this case, polarization independent reflection spectrum can be attained. Moreover, the fabrication technology of FBGs is already well developed, and FBG based dispersion compensators having a dispersion coefficient of about −114.2 ps/nm at a 20-nm or greater range are currently available in the market. A diffraction grating can be formed in various structures at a compound semiconductor (InGaAsP/InP), silica, or polymer waveguide by using a process such as a two-beam hologram process, an E-beam process, and a lithography process. In addition, the RABG of the present invention can be formed in a grating ridge structure or buried heterostructure.

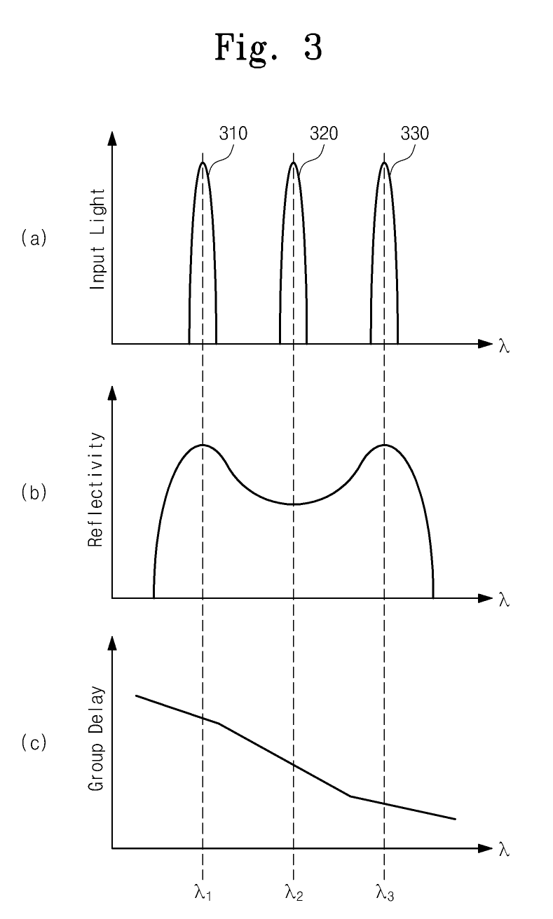

FIGS. 3A through 3C are diagrams for briefly explaining response characteristics of the reflection part 220. With referent to FIGS. 3A through 3C, an explanation will now be given on the wavelength selective reflectivity and group delay characteristics of the reflection part 220 for three exemplary input optical signals 310, 320, and 330.

FIG. 3A shows wavelengths of injection light λᵢₙ, briefly. FIG. 3B shows the reflectivity of the reflection part 220 for the wavelengths, and FIG. 3C shows a decreasing tendency of group delay with respect to wavelength.

FIG. 3B shows the reflection response characteristics of the reflection part 220. The reflectivity of the reflection part 220 is relatively high for short and long wavelengths λ₁ and λ₃ of injection light as compared with a center wavelength λ₂ of the injection light. To obtain this reflection response behavior, parameters of the RABG of the reflection part 220 are adjusted as follows. The RABG is fabricated to have an increased grating parameter (coupling coefficient×grating length) for short and long wavelengths λ₁ and λ₃, and a decreased grating parameter (coupling coefficient×grating length) for a center wavelength λ₂. In this way, the response characteristics of the reflection part 220 shown in FIG. 3B can be attained.

The group delay response characteristics of the reflection part 220 shown in FIG. 3C are expressed as a function of positions of grating ridges and corresponding wavelengths. In detail, in the RABG of the reflection part 220, a grating ridge having a grating period Λ₃ is disposed at a position close to the amplification part 210 for reflecting a long wavelength Λ₃, and a grating ridge having a grating period Λ₁ is disposed at a position distant from the amplification part 210 for reflecting a short wavelength λ₁. A grating ridge having a grating period Λ₂ is disposed at a position corresponding to the middle part of the reflection part 220 for reflecting an intermediate wavelength λ₂. In this case, a long wavelength λ₃ of injection light may be first reflected, and a short wavelength λ₁ of the injection light may be finally reflected. Therefore, owing to this arrangement of the grating ridges of the RABG of the reflection part 220, the group delay response curve of the reflection part 220 can have a negative slope with respect to wavelength λ. Thus, according to the present invention, the upstream source light generator 143 can compensate for chromatic dispersion of an upstream optical signal λᵤ, which occurs according to wavelength when the upstream signal λᵤ propagates through the optical fiber 120.

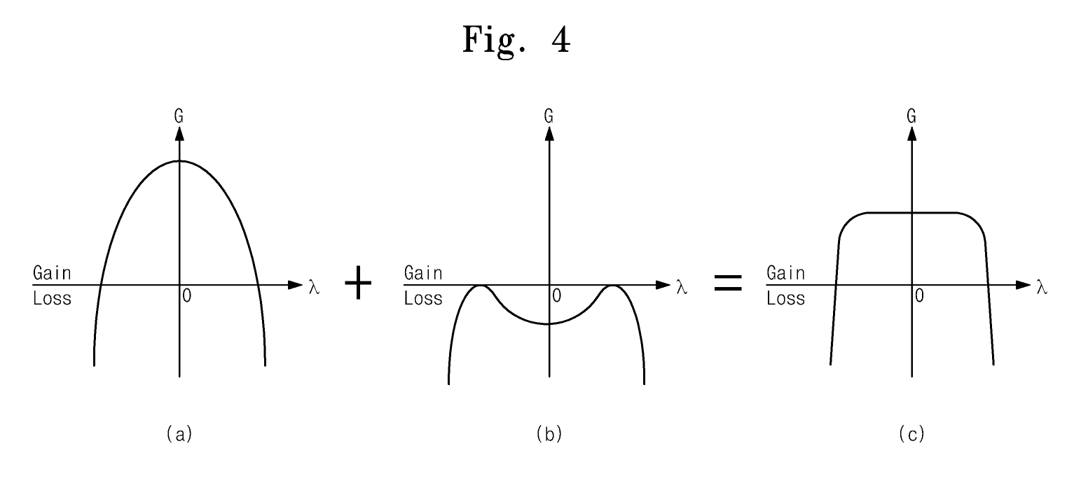

FIGS. 4A through 4C are diagrams for explaining the flat gain response characteristics of the reflection part 220 (refer to FIG. 2). FIG. 4A shows an optical gain curve of the gain medium of the gain waveguide 212. FIG. 4B shows an reflectivity curve of the RABG of the reflection part 220 for injection light λᵢₙ. FIG. 3C shows a flat gain curve of the upstream source light generator 143 with respect to wavelength, which is resulted by the combination of the optical gain curve of the amplification part 210 and the reflectivity curve of the reflection part 220.

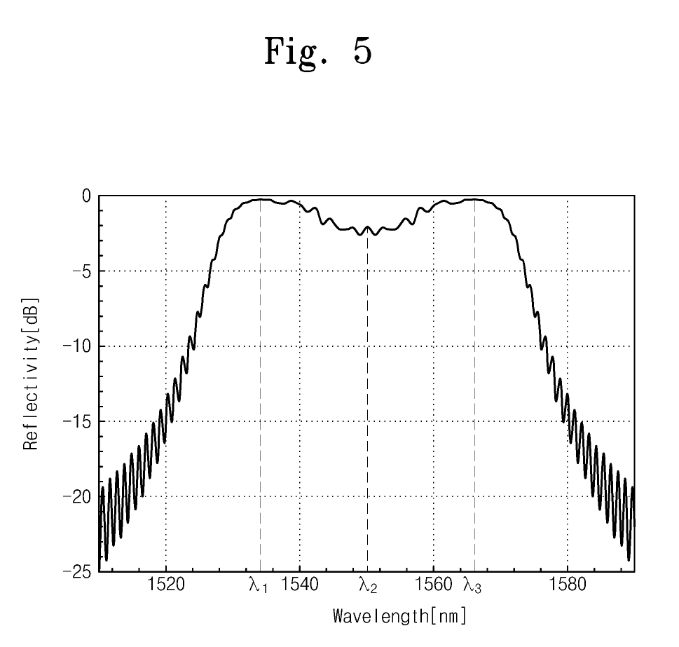

FIG. 5 is a graph illustrating response characteristics of the reflection part 220 (refer to FIG. 2) having the above-described structure according to an embodiment of the present invention. Referring to FIG. 5, results of a simulation performed on the reflection part 220 are shown to explain a gain-wavelength relationship of a silica waveguide. The simulation was performed on the upstream source light generator 143 (refer to FIG. 2) under the following design conditions. The passive waveguide 222 of the reflection part 220 was set to be a silica passive waveguide. The passive waveguide 222 was set to have a diffraction grating structure with an effective refractive index of about 1.5 and a diffraction order of 8. The grating period (about 4 μm) of the passive waveguide 222 was adjusted at each grating region so as to result in the maximal reflectivity at two wavelengths (λ₁=1535 nm, λ₃=1565 nm) and a local minimal reflectivity at a center wavelength (λ₂=1550 nm). In addition, the parameter (coupling coefficient×grating length) was set to 3.44, 1.49, and 3.51 for regions corresponding to the wavelength λ₁, λ₂, λ₃. In the case where the coupling coefficient was 50/cm, the whole grating length was set to about 1.7 mm. The diffraction grating was set to have linear chirping characteristics, and the chirp rate of the diffraction grating was set to 0.9%, 1%, and 0.9% for the wavelengths λ₁, λ₂, and λ₃.

As shown by the simulation results performed in the above-mentioned design conditions, the optical gain characteristics of the gain waveguide 212 can be compensated for by the reflection spectrum characteristics of the reflection part 220. In addition, desired reflection spectrum characteristics can be obtained by adjusting variables such as a grating length and a grating period. In the response characteristics, ripples and side lobes caused by group delay can be easily removed by an apodization method.

In the above-described optical source structure of the present invention, an FP-LD and an RSOA may be included as the amplification part 210. In addition, the amplification part 210 may be replaced with a structure formed by simply coupling a diffraction grating having the above-described spectrum characteristics to an LD or an SOA, so as to attain the same flat gain and dispersion compensation characteristics. That is, according to the present invention, the coupled structure of the amplification part 210 and the reflection part 220 can be used to amply incident injection light at a near wavelength band of the injection light for using the amplified injection light as upstream source light. In addition, according to the present invention, the reflection spectrum characteristics of the reflection part 220 can be designed regardless of gain medium structural variables. Therefore, the present invention can be applied to an asymmetric multiple quantum well FP-LD to provide flat gain characteristics without dependence on structural variables of a gain medium.

As described above, the present invention provides an upstream source light generator having a flat gain and a dispersion compensation function for a WDM-PON system.

Furthermore, according to present invention, a polarization independent ONU, which is insensitive to device structural variables and operational conditions, can be provided with low costs.

In addition, the upstream source light generator can be easily applied to a hybrid-PON and a long-reach PON as well as a WDM-PON.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An upstream source light generator of a passive optical network (PON) system, comprising:
an amplification part configured to amplify injection light; and
a reflection part configured to receive the amplified injection light and generate reflection light by reflecting the amplified injection light with different optical delays according to wavelengths of the amplified injection light,
wherein the reflection part has reflectivity varying according to the wavelengths of the amplified injection light.

2. The upstream source light generator of claim l, wherein the amplification part comprises a gain waveguide configured to amplify the injection light.

3. The upstream source light generator of claim 2, wherein the reflection part comprises:
a passive waveguide configured to guide the amplified injection light; and
a clad layer comprising an asymmetric diffraction grating by which the reflectivity of the reflection part is determined.

4. The upstream source light generator of claim 3, wherein the asymmetric diffraction grating has a variable grating period.

5. The upstream source light generator of claim 4, wherein a grating ridge of the asymmetric diffraction grating having a first grating period is closer to the amplification part than a grating ridge of the asymmetric diffraction grating having a second grating period smaller than the first grating period.

6. The upstream source light generator of claim 3, wherein reflectivities of grating ridges of the asymmetric diffraction grating are set by adjusting grating coefficients or grating lengths of the grating ridges.

7. The upstream source light generator of claim 6, wherein the reflectivities of the grating ridges are adjusted to make a gain of the gain waveguide flat in a pass band of the PON system.

8. The upstream source light generator of claim 1, wherein the amplification part comprises one of an LD (laser diode), an SOA (semiconductor optical amplifier), an FP-LD (Fabry-Perot laser diode), and a RSOA (reflective semiconductor optical amplifier).

9. The upstream source light generator of claim 1, wherein the reflection part comprises an FBG (fiber Bragg grating).

10. The upstream source light generator of claim 1, wherein the reflection part comprises a plurality of thin-film layers formed of different materials.

11. An RSOA comprising:
an optical signal amplification region configured to amplify incident injection light; and
a reflection region configured to reflect the amplified injection light with different reflectivities or optical delays according to wavelengths of the amplified injection light.

12. The RSOA of claim 11, wherein the optical signal amplification region comprises:
a gain waveguide region configured to amplify the injection light with a predetermined optical gain; and
a clad region disposed at a periphery of the gain waveguide region.

13. The RSOA of claim 11, wherein the optical signal amplification region comprises:
a gain waveguide region configured to amplify the injection light with a predetermined optical gain; and
a first clad region disposed at a periphery of the gain waveguide region,
wherein the reflection region comprises:
a passive waveguide region extending from the gain waveguide region; and
a second clad region disposed at a periphery of the passive waveguide region and comprising an asymmetric diffraction grating for the different reflectivities and optical delays of the reflection region.

14. The RSOA of claim 13, wherein the passive waveguide region is formed of the same material as that used for forming the gain waveguide region, and the optical signal amplification region and the reflection region are coupled by monolithic integration.

15. The RSOA of claim 13, wherein the passive waveguide region and the gain waveguide region are formed of different materials, and the optical signal amplification region and the reflection region are coupled by hybrid integration.

16. A method of generating upstream source light in a WDM-PON (wavelength division multiplexed-passive optical network) system including a CO (central office) and an ONU (optical network unit), the method comprising:
amplifying injection light provided by the CO; and
reflecting the amplified injection light with different reflectivities or optical delays according to wavelengths of the amplified injection light so as to output the reflected injection light as upstream source light.

17. The method of claim 16, wherein the reflectivities are adjusted to result in a flat optical gain in a predetermined wavelength region of the amplified injection light.

18. The method of claim 16, wherein the optical delays are reverse proportional to the wavelengths of the amplified injection light.
